(19) United States
(12) Patent Application Publication
(10) Pub. No.: US 2017/0127490 A1
(43) Pub. Date: May 4, 2017

(54) INTELLIGENT LIGHTING APPARATUS

(71) Applicant: BAINIAN HU, Cixi (CN)

(72) Inventor: BAINIAN HU, Cixi (CN)

(21) Appl. No.: 14/928,646

(22) Filed: Oct. 30, 2015

(51) Int. Cl. H05B 33/08; H02J 7/00; H02J 9/06

(52) U.S. Cl. CPC H05B 33/0845; H02J 9/06; H05B 33/0884; H05B 33/0815; H02J 7/0068

(57) ABSTRACT

An intelligent lighting apparatus may have a rechargeable battery, a power processing unit, a power managing unit, a detecting module, and a light source. In one embodiment, the power managing unit is configured to detect a power outage, and when the power outage occurs, the power managing unit can switch the power source to rechargeable battery to continue providing electrical power to the light source. The endurance depends on the capacity of the battery and the power consumption of the light source. In another embodiment, the light source is a regular light bulb. In a further embodiment, the light source is an LED light bulb. In still a further embodiment, the rechargeable battery is a lithium battery. In an exemplary embodiment, the power managing unit in the present invention is configured to enable the light source to be controlled by wall switches even during the power outage.

### FIELD OF THE INVENTION

The present invention relates to a lighting apparatus, and more particularly to an intelligent light apparatus that can be used and operated by wall switches even during power outages.

### BACKGROUND OF THE INVENTION

A conventional light source such as lamps cannot function normally when the power supply of the house is gone. During loss of electrical power, backup lighting systems may engage to provide people with enough light to evacuate or continued activity until normal power is restored. Namely, the backup lighting systems should provide adequate lighting for a sufficient time period to facilitate these purposes.

With the developments in lighting and semiconductor technologies, light emitting diodes (LEDs) are now available in every color in the visible light spectrum as well as infrared and ultra-violet. LED's low energy consumption, long lamp life, and diminutive size make them an attractive option as an emergency lighting source. Step lighting, emergency signs, and pathway lighting are examples of emergency lighting uses where LEDs are now standard. In practice, LEDs are commonly used for emergency and safety lighting purposes.

For most emergency lighting systems, the lighting system is powered its own power sources, such as batteries, U.S. Pat. No. 6,107,744 to Bavaro et al., discloses a backup lighting system comprising a fluorescent bulb, a primary energy source, a sensing means for detecting interruption to power, and a rechargeable secondary energy source for powering the light bulb in the event that the primary energy source fails. However, during power outage, the backup lighting system can still provide light, but it cannot be operated by wall switches.

U.S. Pat. No. 7,347,586 to Izardel discloses an LED lighting device comprising an LED light bulb having a plurality of LEDs mounted along the rim of said light bulb's base. This assembly is surrounded by a reflective shell adapted to redirect light from the LEDs upward thus enhancing the effectiveness of the lighting device. However, the LED light bulb in izardel probably cannot be used as an emergency light, nor operated by wall switches during power outage.

U.S. Pat. Pub. No. 2014/0268697 to Smith et al., discloses a lighting device including two different types of light emitting elements and two different types of power sources for selective illumination. In particular, the lighting device has AC-LEDs and DC-LEDs that are illuminated by an AC power source and a DC power source, respectively, without the need for current conversion. The AC-LEDs and DC-LEDs may be disposed within a LED lamp which is installable in any preexisting light fixture. However, like Izardel, the lighting device disclosed by Smith cannot be operated by wall switches during power outage.

Therefore, there remains a need for a new and improved lighting apparatus or system during power outage not only to provide light, but also to be operated by wall switches.

### SUMMARY OF THE INVENTION

It is an object of the present invention to provide an intelligent lighting apparatus that can be operated by wall switches even during power outage.

It is another object of the present invention to provide an intelligent lighting apparatus having a detecting module to generate a pulse to determine the status of the circuit.

It is a further object of the present invention to provide an intelligent lighting apparatus that can replace existing light bulbs without rewiring.

In one aspect, an intelligent lighting apparatus may have a rechargeable battery, a power processing unit, a micro control unit (MCU), a detecting module and a light source. In one embodiment, the MCU is configured to detect a power outage, and when the power outage occurs, the MCU can switch the power source to the rechargeable battery to continue providing electrical power to the light source. The endurance depends on the capacity of the battery and the power consumption of the light source. In another embodiment, the light source is a regular light bulb. In a further embodiment, the light source is an LED light bulb. In still a further embodiment, the rechargeable battery is a lithium battery.

During the power outage, the MCU is configured to monitor the AC power status and once the power is restored, the MCU can switch the power supply from battery to the AC power and meanwhile charge the battery. It is important to note that during power outage, the detecting module is configured to detect whether the circuit is open or closed, and the MCU is configured to enable the light source to be controlled by wall switches based on the detected status of the circuit. Namely, the intelligent lighting apparatus in the present invention can be used as a regular lighting apparatus (e.g. light bulb) even during power outage.

More specifically, the detecting module may have a pulse generating unit and a pulse receiving unit. When power outage occurs, the detecting module will be activated, and a pulse is generated by the pulse generating unit toward a contact wire L of the light bulb. If the wall switch is turned on, the pulse can travel through the circuit and go back to a contact wire N of the light bulb, and the pulse receiving unit can then receive the pulse, the MCU determines that the circuit where the light bulb is located is closed, and the MCU is configured to turned on the light source.

### BRIEF DESCRIPTION OF THE DRAWINGS

FIG. 1 is a block diagram of the intelligent lighting apparatus in the present invention.

FIG. 2 is a block diagram of the detecting module of the intelligent lighting apparatus in the present invention.

FIGS. 3 and 4 are schematic views of the detecting module of the intelligent lighting apparatus to determine whether the circuit is a closed or an open circuit.

FIG. 5 is another embodiment of the intelligent lighting apparatus in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

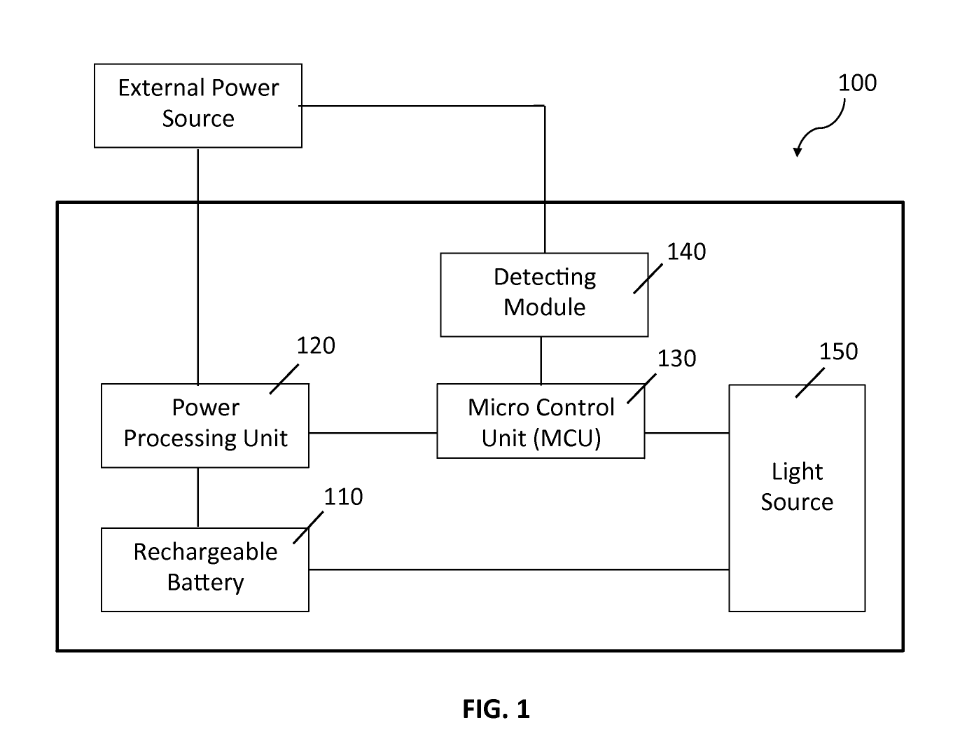

In one aspect, as shown in FIG. 1, an intelligent lighting apparatus 100 may have a rechargeable battery 110, a power processing unit 120, a micro control unit (MCU) 130, a detecting module 140 and a light source 150. In one embodiment, the MCU 130 is configured to detect a power outage, and when the power outage occurs, the MCU 130 can switch the power source to the rechargeable battery 110 to continue providing electrical power to the light source 150. The endurance depends on the capacity of the battery 110 and the power consumption of the light source 150. In another embodiment, the light source is a regular light bulb. In a further embodiment, the light source is an LED light bulb. In still a further embodiment, the rechargeable battery 110 is a lithium battery.

In one embodiment, the power processing unit 120 is configured to convert the electrical power from the external power source (usually alternating current “AC”) to a power that can be used for the light source 150 (usually direct current “DC”). In a further embodiment, the MCU 130 is configured to control the output of the processed power from the external power source, and to prevent the rechargeable battery 110 from being overcharged or over-discharged.

During the power outage, the MCU 130 is configured to monitor the AC power status and once the power is restored, the MCU 130 can switch the power supply from battery 110 to the AC power and meanwhile charge the battery 110. It is important to note that during power outage, the detecting module 140 is configured to detect whether the circuit is open or closed, and the MCU 130 is configured to enable the light source 150 to be controlled by wall switches based on the detected status of the circuit. Namely, the intelligent lighting apparatus 100 in the present invention can be used as a regular lighting apparatus (e.g. light bulb) even during power outage.

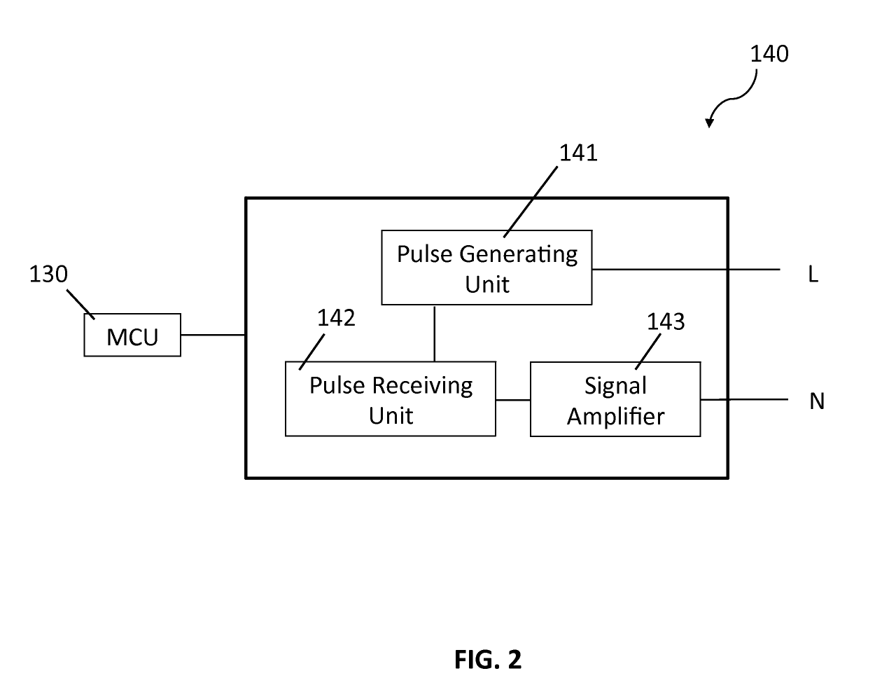

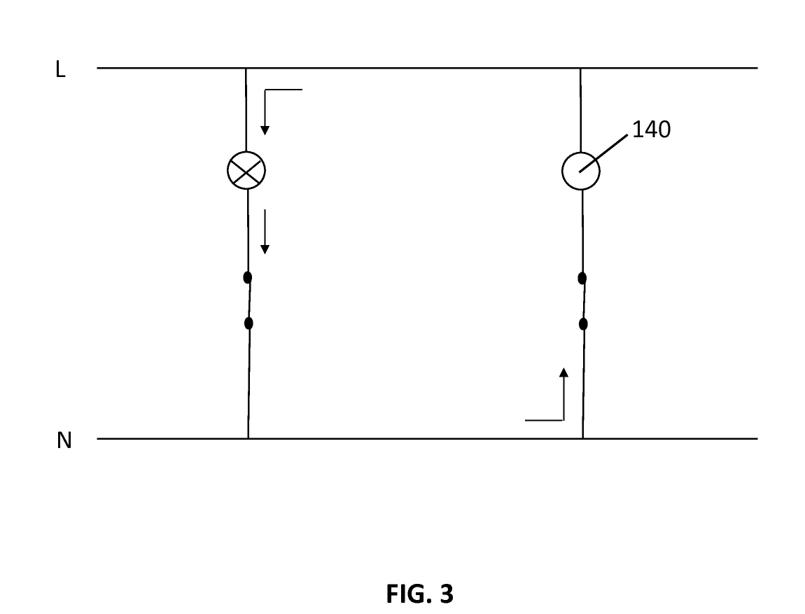

More specifically, as shown in FIG. 2, the detecting module 140 may have a pulse generating unit 141 and a pulse receiving unit 142. When power outage occurs, the detecting module 140 will be activated, and a pulse is generated by the pulse generating unit 141 toward a contact wire L of the light bulb. If the wall switch is turned on, the pulse can travel through the circuit and go back to a contact wire N of the light bulb, and the pulse receiving unit 142 can then receive the pulse as shown in FIG. 3, the MCU 130 determines that the circuit where the light bulb is located is closed, and the MCU 130 is configured to turned on the light source 150. In one embodiment, the detecting module 140 may include a signal amplifier 143.

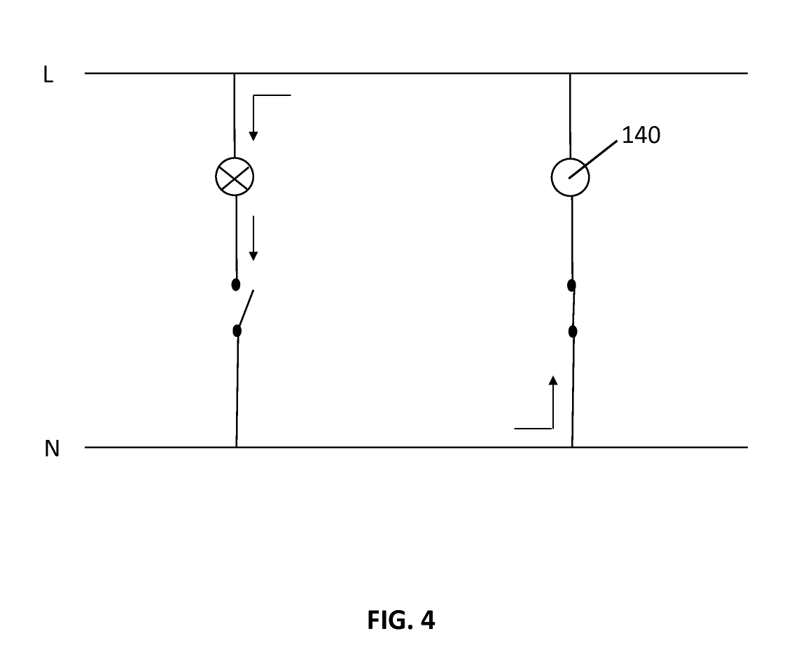

On the other hand, if the wall switch is turned off, namely there is an open circuit as shown in FIG. 4, the pulse generated by the pulse generating unit 141 cannot be received by the pulse receiving unit 142, so the MCU 130 determines that the circuit is open, so the light source 150 will not be turned on. Thus, it is important to note that the light bulb in the present invention can be controlled by the wall switches even during power outage because the MCU 130 can determine whether the circuit is open or closed according to detection results provided by the detecting module 140. If the wall switch is turned on, namely the circuit is closed, the light bulb will be turned on, and vice versa.

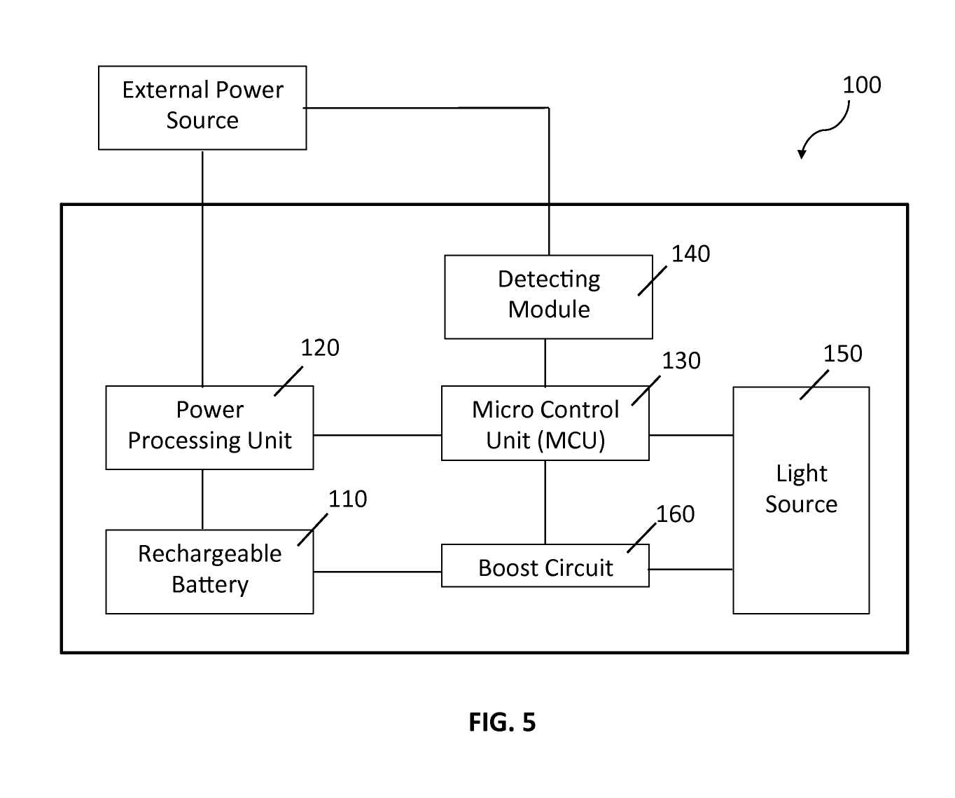

In another aspect, the intelligent lighting apparatus 100 further includes a boost circuit 160 electrically connected to the MCU 130 and light source 150, as shown in FIG. 5. The boost circuit 160 is configured to adjust the brightness of the light source 150.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An intelligent lighting apparatus comprising:
a light source;
a rechargeable battery to provide electrical power to the light source during power outage;
a power processing unit configured to convert an electrical power from an external power source to a power for the light source;
a micro control unit (MCU) to manage input and output of the electrical power, determine whether the power outage occurs and a status of a circuit where the lighting apparatus is located, and control the light source; and
a detecting module that is communicatively and electrically connected with the MCU, and having a pulse generating unit and a pulse receiving unit,
wherein when the power outage occurs, a pulse is generated by the pulse generating unit which is configured to travel around the circuit to determine whether the circuit is open or closed, and the MCU is configured to determine whether to turn on the light source.

2. The intelligent lighting apparatus of claim 1, wherein when the circuit is closed, namely a wall switch for the light source is on, the pulse generated by the pulse generating unit is received by the pulse receiving unit after travelling around the circuit, and the MCU determines that the circuit is closed and turns on the light source.

3. The intelligent lighting apparatus of claim 1, wherein when the circuit is open, namely a wall switch for the light source is off, the pulse generated by the pulse generating unit is not able to travel around the circuit and received by the pulse receiving unit, and the MCU turns off the light source.

4. The intelligent lighting apparatus of claim 1, wherein the rechargeable battery is a lithium battery.

5. The intelligent lighting apparatus of claim 1, wherein the light source is an LED light bulb.

6. The intelligent lighting apparatus of claim 1, wherein the MCU is configured to monitor the AC power status and once the power is restored, the MCU is configured to switch the electrical power from the rechargeable battery to the AC power and meanwhile charge the rechargeable battery.

7. The intelligent lighting apparatus of claim 1, wherein the detecting module further include a signal amplifier.

8. The intelligent lighting apparatus of claim 1, further including a boost circuit electrically connected to the MCU and light source to adjust the brightness of the light source.
